(19) United States
(12) Patent Application Publication
(10) Pub. No.: US 2025/0055044 A1
(43) Pub. Date: Feb. 13, 2025

(54) METHODS AND APPARATUS OF SELF-CHARGING BATTERY DEVICES

(71) Applicant: Bin Rao, Saint Louis, MO (US)

(72) Inventor: BIN RAO, SAINT LOUIS, MO (US)

(73) Assignee: BIN RAO, SAINT LOUIS, MO (US)

(21) Appl. No.: 18/928,036

(22) Filed: Oct. 27, 2024

(51) Int. Cl. H01M 10/36; H01M 10/42

(52) U.S. Cl. CPC H01M 10/36; H01M 10/4257; H01M 10/4264; H01M 2010/4271

(57) ABSTRACT

The entire lifecycle of conventional batteries including lithium-ion batteries—from mining, through manufacturing, to usage—presents significant environmental challenges, including habitat destruction, water and air pollution, resource depletion, and contributions to global warming. This invention disclosure employs a self-charging battery technique based on parametric amplification, a principle first demonstrated by L. Mandelstam and N. Papalexi in 1934, and conceptually supported by Ilya Prigogine's Nobel Prize-winning work in 1977. The parametric amplification process allows the battery device being charged continuously during its life time, and significantly reduces or avoids the environmental pollutions of conventional batteries. Moreover, the features of the self-charging battery devices include long battery life, no off-duty charging time, and safer operation.

### CROSS-REFERENCE TO RELATED APPLICATIONS

None.

### BACKGROUND OF THE INVENTION

This invention disclosure relates to battery systems applicable to various mobile and non-mobile applications, especially in powering up mobile devices such as smart phones.

In recent decades, the rapid advancement of mobile technology has led to the proliferation of smart phones, which have become an integral part of modern life. These devices require efficient and compact energy storage solutions to support their diverse functionalities, including communication, internet access, high-definition video playback, and complex applications. The most commonly used battery type in cell phones is the lithium-ion battery, known for its high energy density, lightweight design, and long cycle life.

However, the growing demand for longer battery life, faster charging, and safer operation presents significant challenges to current battery technologies. Energy density limitations restrict the amount of power a battery can store without increasing its size, which is particularly problematic in the context of thin, lightweight devices.

The environmental pollution associated with conventional batteries, including lithium-ion batteries, arises from multiple stages: mining, manufacturing, and usage. First, the mining of raw materials used in batteries, particularly lithium, cobalt, nickel, and lead, is highly destructive to ecosystems. Lithium extraction often involves water-intensive processes such as evaporation ponds in arid regions, depleting local water supplies and threatening agriculture and wildlife. Similarly, cobalt and nickel mining results in significant soil and water contamination due to toxic byproducts, while open-pit mining scars the landscape, leading to habitat destruction and long-term ecological damage. Both cobalt and nickel extraction require energy-intensive refining processes, which further increase the carbon footprint of battery production.

In the manufacturing stage, producing batteries, especially lithium-ion batteries, is also environmentally harmful. The process is energy-intensive, primarily reliant on coals and fossil fuels. Large amounts of electricity are needed to refine materials, synthesize battery components, and assemble the cells, generating significant greenhouse gas emissions. Additionally, the use of hazardous chemicals, such as lithium salts, solvents, and organic electrolytes, introduces the risk of chemical spills and air pollution due to the release of volatile organic compounds and fluorinated gases. These emissions can negatively affect local air quality and contribute to global warming due to the high global warming potential of the gases used in manufacturing.

The usage of conventional batteries, including lead-acid, nickel-cadmium, and lithium-ion, introduces its own environmental concerns, particularly due to their limited lifespan and potential for leakage. Conventional lead-acid and nickel-cadmium batteries can release toxic heavy metals like lead and cadmium if they are not properly recycled, contaminating soil and water. While Li-ion batteries are generally safer during use, they can still overheat and experience thermal runaway, especially if damaged, leading to potential fires and toxic emissions. The disposal or improper recycling of lithium-ion batteries is also problematic, as it can lead to landfill pollution where metals like cobalt and nickel leach into groundwater.

In summary, the entire lifecycle of conventional batteries including lithium-ion batteries—from mining, through manufacturing, to usage-presents significant environmental challenges, including habitat destruction, water and air pollution, resource depletion, and contributions to global warming. This invention disclosure utilizes a parametric self-charging technique based on the well-known parametric amplification principle first demonstrated in literature by L. Mandelstam and N. Papalexi in 1934. In this document, the term “self-charging battery” is understood as a battery that absorbs environmental energy through its parametric LC oscillators via self-modulation of either the capacitance of a capacitor, the inductance of an inductor, or both at twice the parametric oscillation frequency without external modulation. The physical mechanism behind the parametric amplification is widely understood as environmental energy absorption by the classic physics theory. However, it could also be interpreted as quantum fluctuation energy absorption by the modern quantum field theory, or energy absorption from the Dirac-sea by Dirac's theory of electrons and protons. The parametric amplification process allows the battery device being charged continuously during its life time, and significantly reduces or avoids the environmental pollutions of conventional batteries. Moreover, the features of the self-charging battery devices include long battery life, no off-duty charging time, and safer operation.

### BRIEF SUMMARY OF THE INVENTION

A self-charging battery device comprises: (1) an oscillation starting unit (OSU) that electromagnetically excites the self-modulating LC oscillators beyond a self-sustaining threshold; (2) a parametric oscillation unit (POU) comprising an organized array of electromagnetically connected, self-modulating LC oscillators, which maintain self-charging parametric oscillations through capacitance or inductance self-modulation at twice the parametric oscillation frequency, without requiring external modulation; (3) an energy extraction unit (EEU) that converts a portion of the electromagnetic energy stored in the POU into electrical energy compatible with the application's requirements; (4) an optional control unit (CU) that monitors the battery's operational status, communicates with the application device, and manages the operation of the OSU, POU, and EEU. It is possible not to have a CU in the self-charging battery when there are mechanisms that does not allow the energy inside of POU to grow indefinitely. For example, timely extraction of energy by the EEU could do the job.

In one aspect, the POU comprises multiple parametric oscillation cells, each comprising self-modulating LC oscillators that are parametrically amplified and electrically connected in a ring, with further capacity for expansion by adding rings through electromagnetic connections to enable various topological arrangements and accommodate a larger array of self-modulating LC oscillators within the unit. The total energy inside of the self-charging battery could be easily scaled up by increasing the number of parametric oscillators within each POC or the number of interconnected POCs for supporting larger loads as needed.

In one aspect, each POC within the self-charging battery device comprises a switch, allowing the self-modulating LC oscillators within the cell be activated or deactivated upon the needs of the application.

In another aspect, each POC within the self-charging battery device comprises an even number of self-modulating LC oscillators, and the inductors of the self-modulating LC oscillators are magnetically coupled, forming a magnetic ring structure that enables mutual magnetic enhancement of the inductors' magnetic fields. Optionally, the magnetic ring structure could be electromagnetically coupled with the OSU and the EEU to facilitate the operation of the battery.

In another aspect, one or more sensors could be placed near the POU of the self-charging battery. They can monitor voltages, currents, or magnetic fields of POU and allow communications with the CU that controls the operation of the battery.

In another aspect, a method for self-charging the POU comprises pumping energy into the POU to exceed a self-sustainable threshold while self-modulating the capacitance of capacitors or the inductance of inductors or both within the POU at twice the parametric oscillation frequency.

In another aspect, self-modulation of capacitance is achieved through a voltage-dependent capacitor that consists of two conducting plates serving as electrodes, with nonlinear ferroelectric materials such as barium titanate positioned between them. The capacitor operates in a first parametric zone I, where permittivity increases as the maximum AC voltage amplitude rises, due to the alignment of electrical dipole moments with the external electric field. In a second parametric zone II, permittivity initially increases as the dipole moments align with the electric field but then decreases due to saturation of dipole alignment. This is followed by an increase in permittivity caused by the piezoelectric constriction of the material between the plates as the maximum AC voltage amplitude continues to rise. The self-modulation frequency is twice the frequency of the oscillating AC voltage from the parametric LC oscillator.

In another aspect, self-modulation of inductance is achieved through a current-dependent inductor that comprises a coil with a ferromagnetic core, such as iron or ferrite. Within the parametric zone, the inductor experiences an increase in permeability due to the alignment of magnetic dipole moments with the external magnetic field within the core material in the parametric zone. The self-modulation frequency is twice that of the alternating current frequency.

In another aspect, self-modulation of capacitance is achieved through the voltage-dependent mutual capacitance between a capacitor and its neighboring capacitors. This mutual capacitance increases as amplitudes of AC voltages on these capacitors rise, with the self-modulation frequency being twice that of the AC voltage frequency.

In another aspect, self-modulation of inductance is achieved through the current-dependent mutual inductance between an inductor and its neighboring inductors. This mutual inductance increases as amplitudes of the AC currents passing through these inductors rise, with the self-modulation frequency being twice that of the AC current frequency.

In yet another aspect, the self-modulating inductors are spiral inductors created by winding metal traces in a planar spiral configuration on standard printed circuit boards (PCBs), OR flexible PCBs, or chip substrates.

In a preferred embodiment for applications such as smart phones, the self-charging battery comprises an OSU, a POU, an EEU, and a CU. The OSU comprises an AC current source, one or more LC oscillator, and one or more starting switch. The POU comprises a group of LC oscillators with all components electrically linked in a ring configuration, which can be further expanded by incorporating additional rings through electromagnetic connections, allowing for various topological arrangements to include a larger number of self-modulating LC oscillators within the POU. The EEU comprises one or more LC oscillators, extraction switches, and circuits interfacing with AC or DC loads as required by the application. The inductors of the LC oscillators in the OSU, EEU, and POU are magnetically connected, mutually enhancing their magnetic fields. The parametric amplification mechanism of the LC oscillators is based on the self-modulation of inductance, achieved through current-dependent mutual inductance between each inductor and its neighboring inductors. The inductors in the self-charging battery are preferable spiral inductors, formed by winding metal traces in a planar spiral configuration on standard printed circuit boards (PCBs), flexible PCBs, or chip substrates. The CU manages the activation and deactivation of parametric oscillators within the POU via switches in the POCs and adjusts the EEU's operation based on the application's electricity demands.

### BRIEF DESCRIPTION OF THE DRAWINGS

FIG. 1 illustrates a self-charging battery that comprises an oscillation starting unit, a parametric oscillation unit, an energy extraction unit that generates electricity in the formats required by the application, and a control unit.

FIG. 2 illustrates examples of a parametric oscillation cell featuring LC oscillators electrically connected in a ring configuration.

FIG. 3 presents examples of parametric oscillation units, with their parametric oscillation cells organized in various topological configurations.

FIG. 4 presents three examples of oscillation starting units that excite a parametric LC oscillator.

FIG. 5 illustrates three examples of energy extraction units that extract energy from the parametric LC oscillators within the parametric oscillation unit.

FIG. 6 illustrates the parametric amplification mechanism that is based on a self-modulating nonlinear capacitor.

FIG. 7 depicts the parametric amplification mechanism that utilizes a self-modulating nonlinear inductor.

FIG. 8 illustrates the parametric amplification mechanism based on self-modulating, voltage-dependent mutual capacitance.

FIG. 9 illustrates the parametric amplification mechanism based on self-modulating, current-dependent mutual inductance.

### DETAILED DESCRIPTION OF THE INVENTION

Parametric amplification, first described by L. Mandelstam and N. Papalexi in 1934, can be understood through the analogy of a child's swing. Imagine a child starting in a squatting posture on a swing that has been displaced from its equilibrium position by an initial external force. As the swing reaches its highest point—where potential energy is at its maximum and kinetic energy is zero—the child stands up, fully extending as the swing reaches this peak. At this moment, the system, composed of the swing and the child, has more potential energy than if the child had stayed squatting, due to the work the child did to stand up.

As the swing returns to its lowest point, where kinetic energy is at its maximum and potential energy is zero, the child squats back down. The process repeats: the swing rises again, and the child stands up at the next peak, adding more energy into the system. With each cycle, energy is injected into the system by the child's movement. By the second peak, the total energy equals the original kinetic energy provided by the initial push, plus twice the energy contributed by the child's standing action. As the swing passes through its lowest point, the added potential energy is fully converted into kinetic energy. With each cycle, as the child repeats the action, the energy within the system continues to increase. First it doubles, then quadruples, and so on, steadily growing through the parametric amplification process.

A key feature of the child swing analogy is the presence of two types of energy—potential and kinetic—which continuously alternate as the system cycles between them. Another crucial aspect is that external energy (the work done by the child) is injected into the system twice during each swing cycle. A similar principle operates in electrical systems, such as parametric LC oscillators. In a parametric LC oscillator, energy alternates between two forms: electric field energy stored in a capacitor and magnetic field energy stored in an inductor. Once oscillation begins, the system's energy continually cycles between these states. Like the swing, external energy can be absorbed twice per cycle, as the capacitance or inductance is modulated twice during one cycle.

Though L. Mandelstam and N. Papalexi demonstrated parametric excitation of electrical oscillations as early as 1934, the significance of their discovery remains underappreciated in electrical engineering. John von Neumann recognized the potential of this energy gain mechanism and applied it in the information storage cells of analog computers, as described in U.S. Pat. No. 2,815,488A. Most research on electrical parametric oscillation has focused on parametric transformers and their use in low-frequency power converters instead of energy harvesting. More recently, Mikhail V. Zubkov proposed using thyristors to modulate capacitance or inductance in a patent of a parametric oscillation circuit (RU2386207C2) for harvesting environmental energy. However, the externally controlled connection by thyristor is one-way conduction, and circuits may still be turned on and off in KHz range due to the limited speed of charging and discharging. Nonlinear capacitor using MOSFET channels as shown by U.S. Pat. No. 6,950,299 B2 could potentially be used for parametric amplification circuit as well. But similar challenges arise. Because the energy stored in a capacitor or inductor is very small, the fractional energy that can be extracted out of the parametric LC oscillator is even smaller. A high energy extraction rate, which equals to the parametric oscillation frequency, is required by any meaningful application. The prior art of parametric oscillation circuit is deficient in methods providing high energy extraction rate and extracting meaningful energies for real applications.

For decades, little attention was paid to how energy is transduced from the environment into a system without being returned, raising questions about how a system's energy could seemingly grow indefinitely, assuming the components could store limitless energy. In daily life, we similarly overlook small phenomena, such as a magnet holding itself to a refrigerator door. It appears to defy gravity, yet we know that the magnetic field from the magnet permeates space, making it impossible to enclose the magnet within any closed thermodynamic system. Without energy inputs, the small magnet will not stay on the refrigerator door. In fact, both the small magnet and a parametric oscillation circuit represent a type of thermodynamics system named as thermodynamically open systems in nonequilibrium.

This concept was fully recognized by Ilya Prigogine, who won the 1977 Nobel Prize in Chemistry for his theory of dissipative structures in nonequilibrium thermodynamics. In the case of a parametric oscillation circuit, the electric dipole moment of the capacitor and the magnetic dipole moment of the inductor form an open system that can absorb energy from the environment. The dipole moments serve as energy transducers, continually absorbing energy from their surroundings due to their nonequilibrium nature. In the case of the small magnet, magnetic energy inputs from environment support the magnet standing on the door of the refrigerator.

In a parametric oscillator circuit, as the capacitance or inductance increases, additional energy is absorbed by the system's dipole moments. When these parameters decrease, the absorbed energy is not released back to the environment because the LC oscillators operate as an open system in nonequilibrium. This concept, first demonstrated experimentally in 1934 and later supported by Prigogine's Nobel Prize-winning work, can be applied to the development of a parametric self-charging battery that can actively absorb environmental energy into the battery with zero off-duty time in comparison to a conventional battery in a smart phone that could only be passively charged by another external charging device.

A conventional smartphone battery is considered a thermodynamically closed system in equilibrium, with its internal chemical energy released to power the smartphone for several hours after being fully charged through a process that converts electrical energy from an external charging device into the battery's chemical energy. In contrast, a parametric self-charging battery operates as a thermodynamically open system in nonequilibrium. In traditional electrical circuit design within electrical engineering, current flows from the positive pole of a power source into various components, including capacitors and inductors, before returning to a common ground connected to the negative pole of the power source. This process inadvertently creates and destroys electric and magnetic dipole moments. The destruction of these dipoles causes most traditional electrical circuits to effectively function as closed thermodynamic systems in equilibrium, limiting their ability to absorb energy from the environment along with the dipoles. In contrast, a parametric self-charging battery consists of an organized group of electromagnetically connected, self-modulating LC oscillators that sustain their self-charging parametric oscillations through self-modulation of capacitance or inductance at twice the parametric oscillation frequency, without the need for external modulation. Compared to prior art parametric oscillation devices, the disclosed parametric self-charging battery addresses the problem of limited energy extraction rates by utilizing self-modulating parametric amplification mechanisms that require no external modulation control.

The disclosed parametric modulation mechanisms applicable to the parametric self-charging battery include the self-modulation of capacitance in a single capacitor, the self-modulation of inductance in a single inductor, the self-modulation of mutual capacitance between a capacitor and its neighboring capacitors, and the self-modulation of mutual inductance between an inductor and its neighboring inductors. Among these mechanisms, the self-modulation of capacitance in a single capacitor and the self-modulation of inductance in a single inductor require nonlinear materials, such as ferroelectric materials for nonlinear capacitors and ferromagnetic materials for the cores of nonlinear inductors. The remaining self-modulation mechanisms depend on either electrical field coupling among the capacitors or magnetic coupling between the inductor and its surrounding environment. The organized group of electromagnetically connected, parametrically self-modulating LC oscillators is the core of the self-charging battery device.

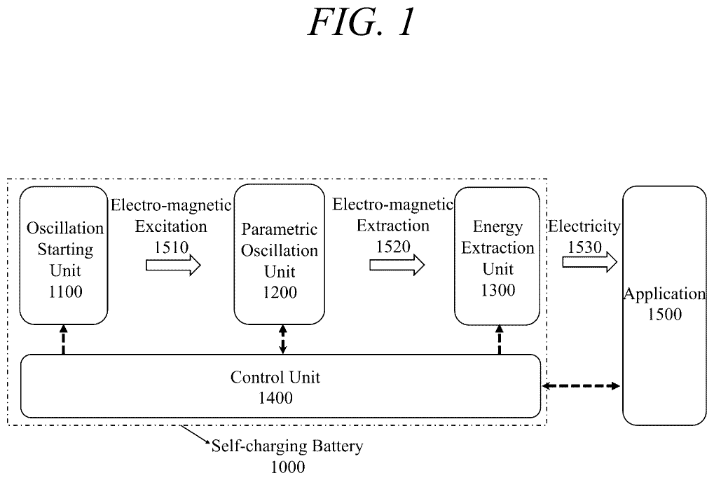

More specifically, as shown in FIG. 1, an example of a self-charging battery device 1000 comprises: (i) an oscillation starting unit (OSU) 1100 that electromagnetically excites self-modulating LC oscillators within the device above a self-sustainable threshold; (ii) a parametric oscillation unit (POU) 1200, which consists of an organized group of electromagnetically connected, self-modulating LC oscillators that sustain their self-charging parametric oscillations through self-modulation of capacitance or inductance at twice the parametric oscillation frequency, without external modulation; (iii) an energy extraction unit (EEU) 1300 that transforms a portion of the electromagnetic energy stored in the POU into the electricity 1530 in the formats required by the application 1500. The arrows representing electromagnetic excitation 1510 and electromagnetic extraction 1520 indicate the direction of energy flow; (iv) a control unit (CU) 1400 that monitors the operational status of the self-charging battery 1000, communicates with the application 1500, and manages the battery's operations. One or more sensors may be placed near POU to monitor the battery's operational status including voltage, current, or magnetic fields. The CU 1400 communicates with the application 1500, senses the battery's operational status, and controls the operations of the OSU 1100, POU 1200, and EEU 1300. It is desirable for the CU 1400 to activate or deactivate parametric oscillators within the POU 1200 or adjust the EEU 1300's operation according to the electricity needs presented by the application 1500.

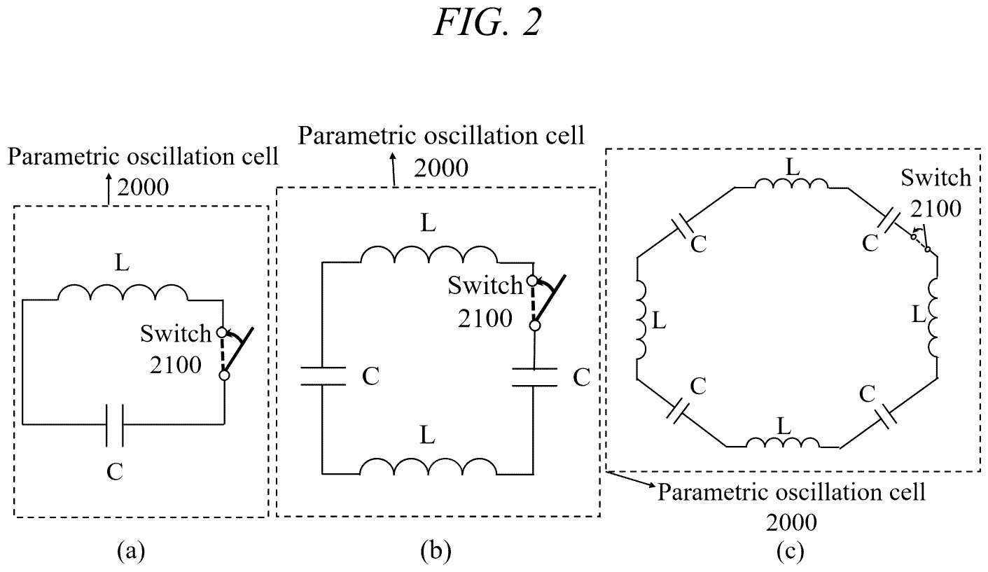

The parametric oscillation unit 1200 comprises multiple parametric oscillation cells (POC) 2000, each comprising self-modulating LC oscillators that are parametrically amplified and electrically connected in a ring, with further capacity for expansion by adding rings through electromagnetic connections to enable various topological arrangements and accommodate a larger array of self-modulating LC oscillators within the unit. Examples of POC 2000 containing one pair, two pairs, and four pairs of parametric LC oscillators are illustrated in FIG. 2(a), FIG. 2(b), and FIG. 2(c), respectively. The switch 2100 within the parametric oscillation cell 2000 enables the control unit 1400 to activate or deactivate all the parametric oscillators within that cell. N pairs of parametric LC oscillators can be arranged in a closed ring configuration without disrupting the electric or magnetic dipole moments. When an even number of pairs of parametric LC oscillators is used, the AC currents flowing through these inductors can be either in phase or out of phase. It is preferable to magnetically link these even-numbered inductors into a ring shape, allowing their magnetic fields to enhance one another.

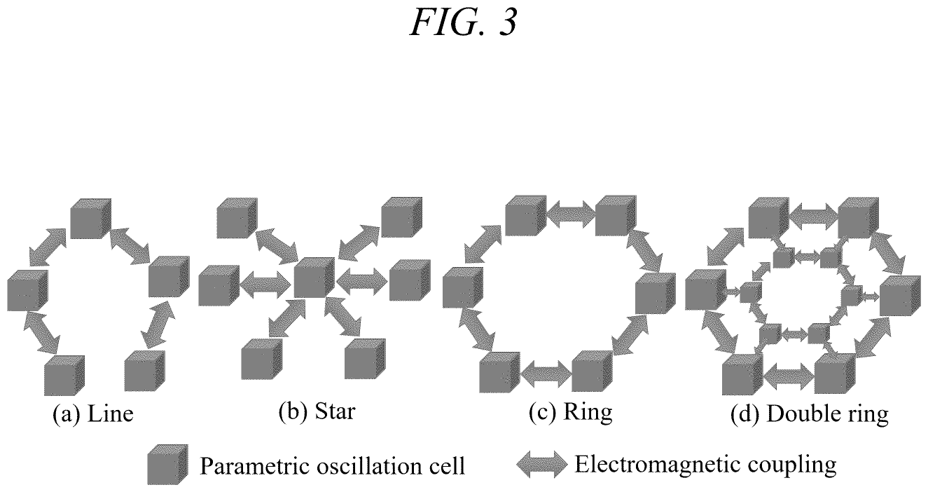

It is recognized that the total energy contained within the parametric oscillation unit 1200 is directly proportional to the number of pairs of parametric LC oscillators present. A larger total number of pairs allows for greater energy extraction for application purposes. FIG. 3 (a, b, c, d) illustrates examples of scalable parametric oscillation units 1200 formed by electromagnetically coupling multiple parametric oscillation cells 2000 into various topological configurations, including line, star, ring, and double ring formations.

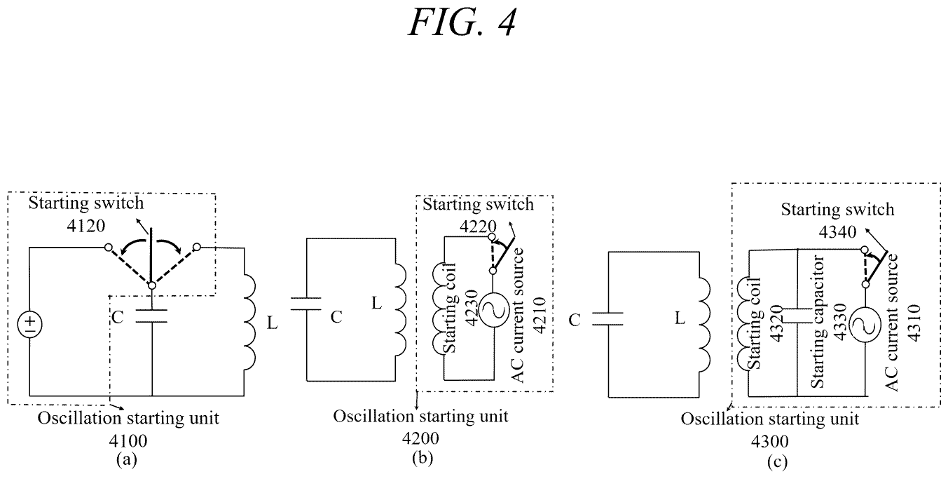

FIG. 4 illustrates examples of oscillation starting units 1100 capable of electromagnetically exciting self-modulating LC oscillators beyond a self-sustainable threshold. The oscillation starting unit 4100 in FIG. 4(a) comprises a DC voltage source (or a rectified DC voltage power source, or a voltage device made from electret material) 4110 and a starting switch 4120 with two positions or states. In this configuration, the starting switch 4120 allows the DC voltage source 4110 to charge the capacitor in the parametric LC oscillator by closing the left half of the circuit. The oscillation commences when the starting switch 4120 closes the right half of the circuit after the capacitor is fully charged.

The oscillation starting unit 4200 in FIG. 4(b) features an AC current source 4210 with a frequency matching the LC oscillation frequency, a starting switch 4220, and a starting coil 4230. Starting energy is transferred to the parametric LC oscillator through magnetic coupling between the starting coil 4230 and the inductor of the parametric LC oscillator. When the starting switch 4220 is engaged, the parametric LC oscillator is activated. The longer the switch remains on, the more energy is injected into the parametric LC oscillator. Once the oscillator becomes self-sustainable, the starting switch 4220 can be turned off.

The oscillation starting unit 4300 in FIG. 4(c) consists of an AC current source 4310, a starting coil 4320, a starting capacitor 4330, and a starting switch 4340. Here, the starting coil 4320 and the starting capacitor 4330 can form a parametric LC oscillator. The resonant frequency of the starting coil 4320 and the starting capacitor 4330 matches the resonant frequency of the parametric LC oscillator. Although FIG. 4(c) depicts only one pair of starting oscillators (the starting coil 4320 and the starting capacitor 4330), multiple pairs of parametric starting oscillators can be employed. The starting switches in FIG. 4(a), FIG. 4(b), and FIG. 4(c) effectively preserve the electric and magnetic dipole moments of the parametric LC oscillator.

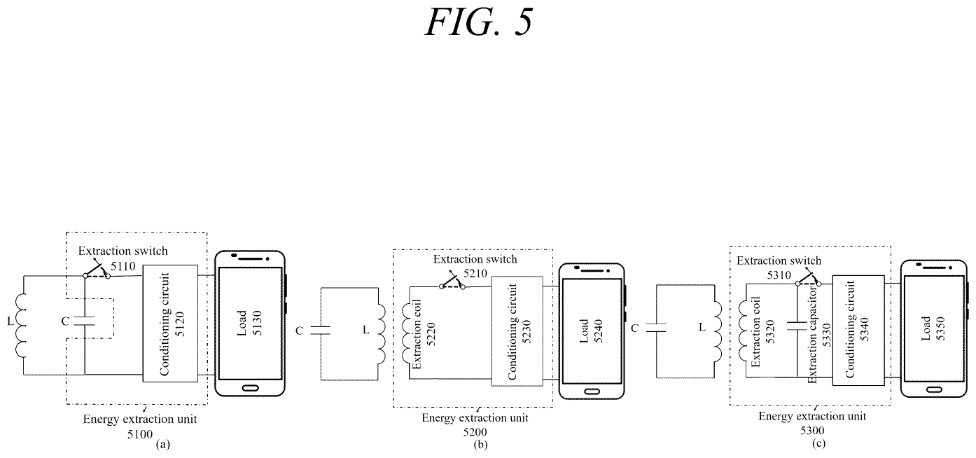

FIG. 5 presents examples of how energy can be extracted from the parametric LC oscillators within the self-charging battery by various energy extraction units. The energy extraction unit 5100 in FIG. 5(a) comprises an extraction switch 5110 and a conditioning circuit 5120 that powers the load 5130. When the extraction switch 5110 is activated, the voltage on the capacitor drives the conditioning circuit 5120, which is carefully designed not to disturb the phase of the electric and magnetic dipoles within the parametric LC oscillator.

The energy extraction unit 5200 in FIG. 5(b) comprises an extraction switch 5210, an extraction coil 5220, and a conditioning circuit 5230 that powers the load 5240. The use of the extraction coil 5220 provides effective isolation between the parametric LC oscillator and the energy extraction circuits, ensuring smooth energy transfer without disrupting the oscillation.

The energy extraction unit 5300 in FIG. 5(c) includes an extraction switch 5310, an extraction coil 5320, an extraction capacitor 5330, and a conditioning circuit 5340 that powers a load 5350. The extraction coil 5320 and the extraction capacitor 5330 can form a parametric LC oscillator, with both components tuned to resonate at the same frequency as the parametric LC oscillator. While FIG. 5(c) illustrates a single pair of extraction oscillators consisting of the extraction coil 5320 and the extraction capacitor 5330, multiple pairs of parametric extraction oscillators could be utilized.

The extraction switches in FIG. 5(a), FIG. 5(b), and FIG. 5(c) are designed to avoid disrupting the electric and magnetic dipole moments of the parametric LC oscillator during energy extraction. It should also be noted that an energy extraction unit may incorporate a combination of the energy extraction circuits shown in FIG. 5(a), FIG. 5(b), and FIG. 5(c). Additionally, feedback devices that monitor the maximum AC voltage or current amplitudes in the parametric LC oscillators are essential for controlling the energy levels, allowing timely extraction of energy to maintain optimal operation.

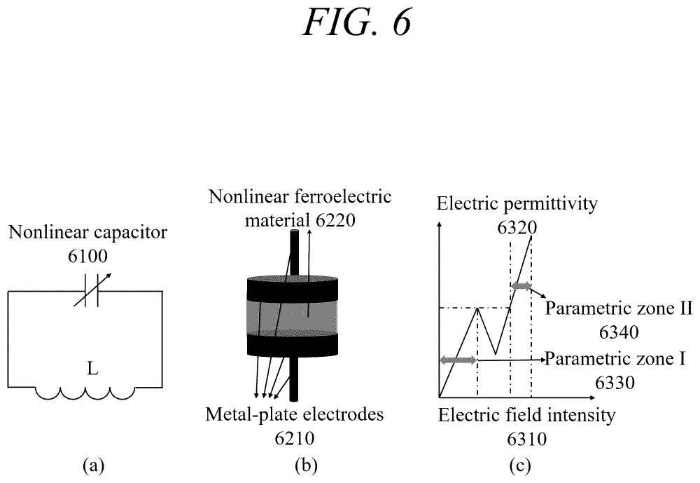

The self-charging battery 1000 employs parametric self-modulation mechanisms that enable the parametric oscillation frequency to be adjusted to a desirable frequency for a given application. In the case of powering a smartphone, while the energy stored in a single parametric LC oscillator may be relatively small, sufficient electricity can be extracted at a high extraction rate from a large array of LC oscillators, all operating at high resonance frequencies. FIGS. 6-9 illustrate various examples of parametric self-modulation mechanisms.

Examples of nonlinear capacitors utilizing nonlinear materials can be found in U.S. Pat. No. 2,695,239A and 4807085A. FIG. 6(a) illustrates the schematic of a parametric LC oscillator using a nonlinear capacitor 6100, where the capacitance is self-modulated by the voltage applied to the nonlinear capacitor at twice the parametric oscillation frequency. The nonlinear capacitor 6100, as shown in FIG. 6(b), consists of two metal-plate electrodes 6210 with a nonlinear ferroelectric material 6220 sandwiched between them. FIG. 6(c) depicts a typical relationship between the electric permittivity of the nonlinear ferroelectric material 6320 and the electric field intensity 6310. Initially, the permittivity increases as the electric dipole moments in the material align with the external electric field. This is followed by a decrease in permittivity due to saturation, and then another increase caused by piezoelectric constriction of the material as the AC voltage amplitude between the plates continues to rise. The maximum AC voltage or current amplitude must fall within a parametric zone for parametric amplification to occur. The LC oscillator can operate within either parametric zone I 6330 or parametric zone II 6340 to enable the parametric amplification mechanism, though it is preferable to operate in parametric zone II 6340 to achieve greater parametric amplification.

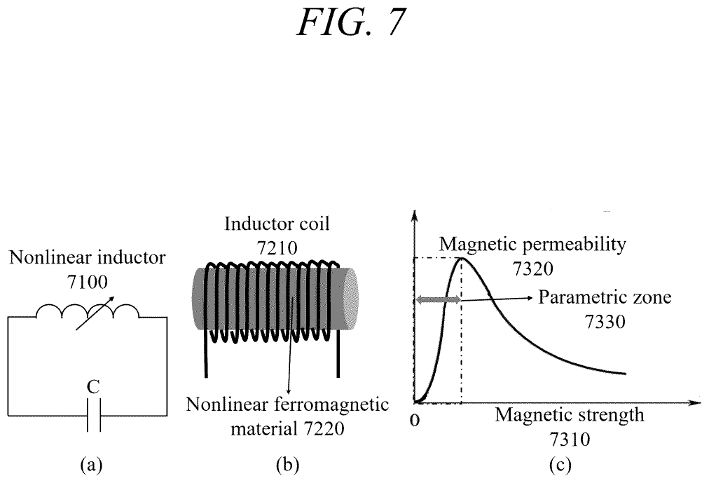

In a similar way, oscillations within the LC oscillator can be parametrically amplified using a nonlinear inductor. FIG. 7(a) shows the schematic of a parametric LC oscillator using such a nonlinear inductor 7100, where the inductance is self-modulated by the current passing through the nonlinear inductor at twice the parametric oscillation frequency. The construction of the nonlinear inductor is illustrated in FIG. 7(b), where the hollow space inside the inductor coil 7210 is filled, or partially filled, with nonlinear ferromagnetic material 7220. The cylindrical shape of the nonlinear ferromagnetic material 7220 may also be tube-shaped. As depicted in FIG. 7(c), the magnetic permeability 7320 initially increases with the magnetic field strength 7310 until the magnetic saturation point is reached, after which the permeability 7320 decreases as the magnetic field strength 7310 increases further beyond saturation. The LC oscillator must operate within the parametric zone 7330 for parametric amplification to occur.

It is noteworthy that the parametric zone 7330 in FIG. 7(c) and the parametric zone I in FIG. 6(c) provide limited parametric amplification, whereas parametric zone II in FIG. 6 offers a more robust parametric self-modulation mechanism that is suitable for a wider range of applications. Additionally, feedback devices can be used to ensure that the maximum AC voltage or current amplitude remains within the desired parametric zone.

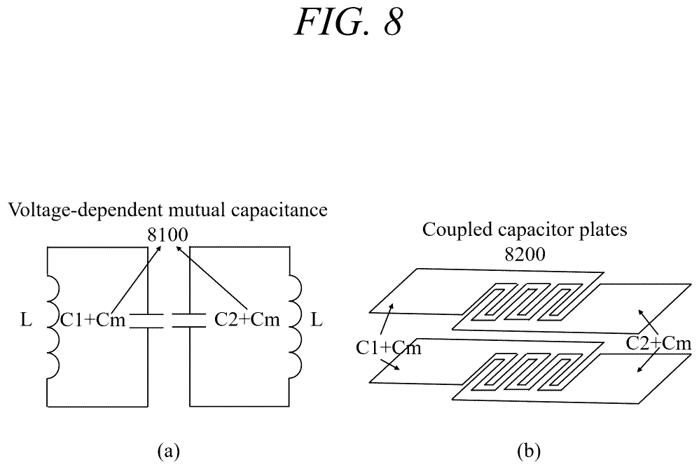

FIG. 8 illustrates a parametric self-modulation mechanism based on voltage-dependent mutual capacitance. The voltage-dependent mutual capacitance 8100 emerges when the electric fields of two capacitors within neighboring parametric LC oscillators enhance one another, as schematically shown in FIG. 8(a). An example of constructing such neighboring capacitors is depicted in FIG. 8(b), where coupled capacitor plates 8210 interact in a zone where the electric field lines from both capacitors are coupled. In this configuration, the stronger the electric field in the first capacitor (C1), the more charge accumulates in the second capacitor (C2), increasing its capacitance. As more charge accumulates in C2, its electric field strengthens, which in turn increases the charge accumulation and capacitance of C1. This feedback loop continues until maximum mutual capacitance is achieved, at which point the electric dipole moments in the capacitors become fully saturated. Thus, the mutual capacitance 8100 increases as amplitudes of the alternating-current voltages on these capacitors rise.

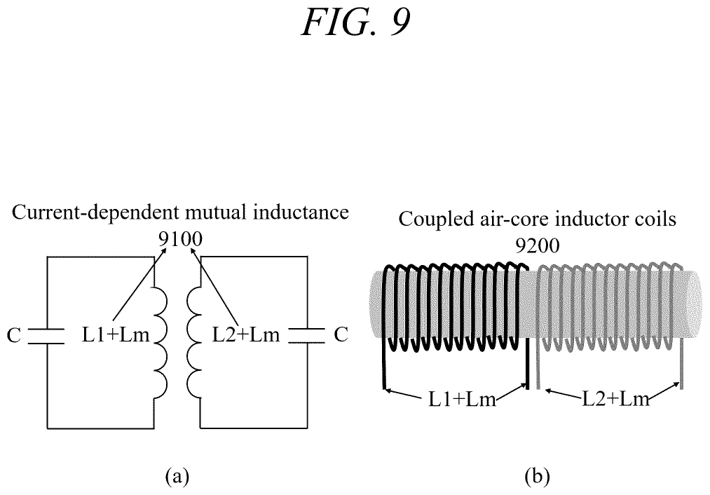

FIG. 9 illustrates a parametric self-modulation mechanism based on current-dependent mutual inductance. The current-dependent mutual inductance 9100 occurs when the magnetic fields of two inductors within neighboring parametric LC oscillators enhance one another, as schematically shown in FIG. 9(a). An example of constructing such neighboring inductors is depicted in FIG. 9(b), where the two inductor coils share a common air core, allowing their magnetic fields to interact and reinforce each other. In this configuration, a stronger current in the first inductor (L1) generates a stronger magnetic field. This increased magnetic field enhances the mutual inductance (Lm) experienced by the second inductor (L2), resulting in a larger effective inductance (L2+Lm), which increases the energy and current in L2, further amplifying its magnetic field. As L2's magnetic field grows, the mutual inductance Lm acting on L1 increases, boosting its effective inductance (L1+Lm), thereby increasing the energy and current in L1, and strengthening its magnetic field. This feedback loop can continue as long as the electrical components can handle the increasing energy. Since the common air core of L1 and L2 does not saturate, this process can persist without magnetic saturation. Thus, the mutual inductance 9100 increases as amplitudes of the alternating currents passing through these inductors rise. Energy inside the parametric oscillators need to be extracted in a timely manner. Optionally, a switch can be used to deactivate the parametric oscillators as needed.

The self-charging battery has two crucial parameters: the total energy stored in the battery and the energy absorption rate from the environment. The total energy stored in the battery is equal to the total number of parametric LC oscillators multiplied by the energy stored in each individual parametric LC oscillator. The energy absorption rate is defined as the amount of energy absorbed into the battery per second. This rate is calculated by multiplying the self-modulation depth of the capacitance or inductance of the parametric LC oscillator by the total energy stored in the battery. Both the energy absorption rate and the energy extraction rate should match with the energy consumption rate of the application.

It is possible that the self-charging battery is a distributed battery system comprising multiple partitions serving their own local electricity needs. There might not be a clear divided boundary between the self-charging battery and the application circuits because they are merged together. Still, the same principles apply: (1) The circuit design does not kill the dipole moments in the parametric oscillation unit; (2) The environmental energy is absorbed into the battery with the parametric self-modulation mechanisms, and extracted out as usable electricity in the formats, such as voltage, current, magnetic field, electrical field, and electromagnetic radiations, as needed by the application in a controlled and timely manner.

### REFERENCES CITED

### U.S. Patent Documents

| | |
|---|---|
| 2695239A | Filed in May 1951 by Howard I Oshry |
| 2815488A | Filed in April 1954 by Neumann John Von |
| 4807085A | Filed in May 1987 by Minoru Yasukawa et al. |
| 6950299B2 | Filed in February 2004 by Nicholas J. Stone et al. |

### Foreign Patent Documents

RU2386207C2 Filed in January 2008 by Mikhail V. Zubkov et al.

### Other Publications

Dilip Kondepudi and Ilya Prigogine, Modern Thermodynamics: From Heat Engines to Dissipative Structures, Wiley, Chichester (1998).
Eyup Salih Tez, The Parametric Transformer, Ph.D. Thesis (1977).
L. Mandelstam and N. Papalexi, “Parametric excitation of electric oscillations,” Zhurnal Teknicheskoy Fiziki, 4(1), 5-29 (1934).
P. A. M. Dirac, “A theory of electrons and protons,” Proceedings of the Royal Society of London, Series A, 126(801), January 1, 360-365 (1930).

What is claimed is:

1. A self-charging battery device comprising an oscillation starting unit (OSU) that electromagnetically excites self-modulating LC oscillators above a self-sustainable threshold, a parametric oscillation unit (POU) that includes an organized group of electromagnetically connected, self-modulating LC oscillators sustaining self-charging parametric oscillations through self-modulation of capacitance, inductance, or both at twice the parametric oscillation frequency without external modulation, an energy extraction unit (EEU) that converts part of the electromagnetic energy stored in the POU into electricity suitable for application requirements, and an optional control unit (CU) that monitors battery status and regulates the operation of the OSU, POU, and EEU.

2. A self-charging battery device as claimed in claim 1, wherein the parametric oscillation unit comprises multiple parametric oscillation cells, each consisting of self-modulating LC oscillators that are parametrically amplified and electrically connected in a ring, with the ability to expand through additional electromagnetically connected rings to support various topological arrangements and accommodate a larger array of self-modulating LC oscillators.

3. A self-charging battery device as claimed in claim 2, wherein each parametric oscillation cell includes a switch that enables activation or deactivation of the self-modulating LC oscillators within the cell based on application needs.

4. A self-charging battery device as claimed in claim 2, wherein each parametric oscillation cell comprises an even number of self-modulating LC oscillators with magnetically coupled inductors that form a magnetic ring structure to enable mutual magnetic enhancement of the inductors' magnetic fields.

5. A self-charging battery device as claimed in claim 4, wherein the magnetic ring structure is electromagnetically coupled with the oscillation starting unit and the energy extraction unit to support battery operation.

6. A self-charging battery device as claimed in claim 1, wherein one or more sensors are positioned near the parametric oscillation unit to monitor voltage, current, or magnetic fields and communicate with the control unit to regulate battery operation.

7. A method for self-charging a parametric oscillation unit, comprising pumping energy into the unit to exceed a self-sustainable threshold while self-modulating the capacitance, inductance, or both within the unit at twice the parametric oscillation frequency.

8. A method of claim 7, wherein self-modulation of capacitance is achieved through the voltage-dependent capacitance of a capacitor composed of two conducting plates serving as electrodes, with a nonlinear ferroelectric material, such as barium titanate, positioned between them and operating within the parametric zones.

9. A method of claim 7, wherein self-modulation of inductance is achieved through the current-dependent inductance of an inductor with a coil featuring a ferromagnetic core, such as iron or ferrite, which experiences increased permeability due to the alignment of magnetic dipole moments with the external magnetic field within the core material in the parametric zone.

10. A method of claim 7, wherein the self-modulation of capacitance is achieved through the voltage-dependent mutual capacitance between a capacitor and its neighboring capacitors, with the mutual capacitance increasing as the amplitudes of the alternating-current voltages on these capacitors rise.

11. A method of claim 7, wherein the self-modulation of inductance is achieved through the current-dependent mutual inductance between an inductor and its neighboring inductors, with the mutual inductance increasing as the amplitudes of the alternating currents passing through these inductors rise.

12. A method of claim 11, wherein the inductors are planar spiral inductors printed on circuit boards or chip substrates.
